(19) United States
(12) Patent Application Publication
(10) Pub. No.: US 2005/0269734 A1
(43) Pub. Date: Dec. 8, 2005

(54) Multifunction multilayer PTFE tape and method of manufacture

(75) Inventor: Charles T. Williams, Bristol, PA (US)

Correspondence Address: John M. Harrington;Kilpatrick Stockton LLP, 1001 West Fourth Street, Winston-Salem, NC, 27101, US

(73) Assignee: Coltec Industrial Products LLC

(21) Appl. No.: 11/144,164

(22) Filed: Jun. 3, 2005

Related U.S. Application Data
(60) Provisional application No. 60/576,639, filed on Jun. 3, 2004.

(51) Int. Cl. B29C 47/06; B32B 1/08

(52) U.S. Cl. 264/173.11; 428/411.1

(57) ABSTRACT

A multilayer fluoropolymer-based tape is provided comprising a first layer having a first functional property, a second layer comprising a second functional property and an interstitial tie layer formed from the fibrillation of said adjoining first and second layers during extrusion. Further, a method for manufacturing a multilayer multifunctional fluoropolymer-based tape is provided comprising the steps of: a) selecting a first fluoropolymer-based composition comprising a first functional property, b) selecting a second fluoropolymer-based composition comprising a second functional property different from said first functional property, c) forming a first preform from said first fluoropolymer-based composition, d) forming a second preform from said second fluoropolymer-based composition, e) loading the first and second preforms into an extruder, and f) actuating a ram to force said first and second preforms through a die to form an extruded product comprising a first layer and a second layer physically bonded through a tie layer disposed therebetween. The tie layer comprises a mixture of the material of said first layer and said second layer formed through interstitial fibrillation of the two layers during extrusion.

### CROSS REFERENCE TO RELATED APPLICATIONS

The present application claims priority under 35 U.S.C. § 119(e) from U.S. Provisional Patent Application Ser. No. 60/576,639 filed Jun. 3, 2004, entitled “MULTIFUNCTION MULTILAYER POLYTERAFLUOROETHYLENE TAPE AND METHOD OF MANUFACTURE”, the disclosure of which is incorporated herein by reference.

### FIELD OF THE INVENTION

The present invention relates to a multilayer polytetrafluoroethylene (PTFE) tape and method of manufacture. More particularly the present invention relates to a method for making a preform comprising at least two different PTFE compounds, then ram extruding the preform to yield a multilayered tape article.

### BACKGROUND OF THE INVENTION

PTFE-based tapes are commonly used to wrap wires. Often two tapes are employed with an inner tape comprising one functional characteristic and an outer tape comprising an additional characteristic. As the exterior jacket of a wire is most likely to first come into contact with sharp edges inside an aerospace craft, and other objects, it is preferred that such exterior jacket be durable. Additionally, it is important that the jacket have sufficient flexibility such that it does not crack or break upon bending. Often these exterior wraps are marked with a laser to provide identification of the wire. Unfortunately, the additives used in PTFE-based tapes often conflict with one another such that they cannot be combined in a single homogenous tape product. For example, the incorporation of various pigments used to provide laser markability limits the ability to improve properties such as mechanical and arc resistance.

The prior art has addressed the problem of deriving multiple functions from a PTFE-based tape by incorporating separate functionalities into separate layers of PTFE-based tape, then laminating the layers together to form a finished article. For example, U.S. Pat. No. 6,833,178, entitled “Multilayer Laminated Structure, In Particular For Wrapping Electric Cables”, and herein incorporated by reference, related to a multilayer laminated structure comprising a polyimide layer coated on at least one of its faces in FEP, and at least one layer of PTFE bonded to said FEP-coated polyimide layer, said layers being formed by tapes that are bonded together while hot with pressure being applied, each PTFE tape being made of green PTFE obtained by lubricated extrusion and being united with the FEP-coated polyimide tape at a temperature that is lower than the sintering temperature of PTFE.

There are some significant limitations associated with the above-described processes when applied to multilayer PTFE. First, the voids between the layers left behind by surface irregularities in the individual tape layers weakens the adhesion between the layers of PTFE and reduces the strength of the bond particularly during calendaring operations. Second, sintering often produces dimensional changes within the PTFE layers, which affect strength and performance characteristics. Thirdly, multilayer tapes with the aforementioned defects may be weakened in successive stretching operations.

These problems are magnified when the two PTFE-based layers differ in structure and properties. As discussed above, this often arises from the additives employed to achieve the distinct functionalities desired in the finished article. When produced according to the above described methods, the operations of sintering and calendering weaken the interfacial adhesion between the two types of PTFE. As such, heretofore, a multilayer PTFE sheet with mutually exclusive properties such as abrasion resistance and arc track resistance has proven difficult to manufacture.

Therefore, it is an object of the present invention to provide a multilayer PTFE tape article which exhibits multiple functionalities without sacrificing mechanical strength, adhesion between the layers, and retention of the individual qualities of the constituent materials while overcoming the deficiencies of the prior art.

### SUMMARY OF THE INVENTION

In a first aspect of the present invention, a method for manufacturing a multilayer multifunctional fluoropolymer-based tape is provided comprising the steps of: a) selecting a first fluoropolymer-based composition comprising a first functional property, b) selecting a second fluoropolymer-based composition comprising a second functional property different from said first functional property, c) forming a first preform from said first fluoropolymer-based composition, d) forming a second preform from said second fluoropolymer-based composition, e) loading the first and second preforms into an extruder, and f) actuating a ram to force said first and second preforms through a die to form an extruded product comprising a first layer and a second layer physically bonded through a tie layer disposed therebetween. The tie layer comprises a mixture of the material of said first layer and said second layer formed through interstitial fibrillation of the two layers during extrusion.

In another embodiment of the present invention, the first functional property comprises at least one of laser markability, abrasion resistance, arc track resistance, flexibility, bondability, stretchability, wear resistance, heat aging and weathering, insulative properties, porosity, UV resistance, and hydraulic resistance.

In a further embodiment of the present invention, the second functional property comprises at least one of laser markability, abrasion resistance, arc track resistance, flexibility, bondability, stretchability, wear resistance, heat aging and weathering, insulative properties, porosity, UV resistance, and hydraulic resistance.

In a still further embodiment of the present invention, a finished article is provided comprising two primary layers and a tie layer comprising a mixture of the material of the two primary layers formed through the above described process.

In another aspect of the present invention, a multilayer fluoropolymer based tape is provided comprising a first layer having a first functional property, a second layer comprising a second functional property and an interstitial tie layer formed from the fibrillation of said adjoining first and second layers during extrusion.

The multifunctional preform of the present invention facilitates the combination of targeted performance properties and combines them in a manner that promotes homogeneity in the post-preform processing step. In one embodiment of the present invention, a method is provided which allows the direct combination of specific properties such as mechanical resistance and arc track resistance.

The prior art has not addressed a multilayer PTFE sheet combining the performance enhancement of laser markability coupled with mechanical resistance and arc track resistance, largely due to the limitations of the prior art processes discussed above. It is through the process of the present invention that previously non-combinable PTFE combinations may be formed into a finished tape article.

The process of the present invention overcomes many of the problems associated with the prior art PTFE compositions, providing the ability to fabricate PTFE-based tapes with multiple characteristics including: laser markability, abrasion resistance, arc track resistance, flexibility, bondability, stretchability, wear resistance, heat aging and weathering, insulative properties, porosity, UV resistance, hydraulic resistance and/or layer-layer homogeneity across the tape.

As will be realized by those of skill in the art, many different embodiments of a multifunction multilayer PTFE tape according to the present invention are possible. Additional uses, objects, advantages, and novel features of the invention are set forth in the detailed description that follows and will become more apparent to those skilled in the art upon examination of the following or by practice of the invention.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

So that the manner in which the above-recited features, advantages and objects of the invention, as well as others which will become more apparent, are obtained and can be understood in detail, a more particular description of the invention briefly summarized above may be had by reference to the embodiment thereof which is illustrated in the appended drawings, which drawings form a part of the specification and wherein like characters of reference designate like parts throughout the several views. It is to be noted, however, that the appended drawings illustrate only preferred and alternative embodiments of the invention and are, therefore, not to be considered limiting of its scope, as the invention may admit to additional equally effective embodiments.

### DETAILED DESCRIPTION

The present invention provides a high performance multilayered PTFE tape and method of constructing a multilayered PTFE tape by combining the performance properties of at least two PTFE tape layers while overcoming the interfacial weakness of typical calendering operations. As outlined above, in current practice when two layers of PTFE are combined to produce a multifunctional article, the two tapes are separately extruded, then brought together sintered and calendared to achieve the desired thickness. However, these processes adversely affect mechanical strength and resistance to abrasion primarily due to lack of adhesions between layers. The present invention overcomes these limitations to produce a multifunctional PTFE tape which exhibits strong bonding between the layers.

In a preferred embodiment of the present invention, the functional properties combined through the method of the present invention comprise: laser markability, abrasion resistance, arc track resistance, flexibility, bondability, stretchability, wear resistance, heat aging and weathering, insulative properties, layer-layer homogeneity, and/or hydraulic resistance. The particular additives to PTFE that impart these characteristics are often mutually exclusive or will enhance one property while degrading another.

For example, various metal oxides, such as titanium oxide, are added to PTFE tapes to improve the laser markability of the tape. However, the addition of metal oxides decreases the electrical resistance of the tape as these oxides act as conductors. When the PTFE tape is to be used to wrap a wire, high electrical resistance is an obvious necessity. In the prior art, it is necessity to employ two separate PTFE tapes, an inner tape to guard against arc tracking and an outer tape including metal oxides to provide laser markability.

In a first aspect of the present invention, a composite preform is formed from at least two separate preforms comprising PTFE components with different functional properties. First, the desired functional properties for the final multilayer tape product are identified. PTFE-based compositions comprising these functional properties are then selected for the individual preforms. The PTFE compositions are formed into separate preforms by mixing PTFE powder with the additives associated with said desired functional properties and adding a lubricant. The lubricated PTFE-based composition is placed into a mold comprising the desired final shape of the preform and pressed to compress the powder into a single solid preform.

In a preferred embodiment of the present invention, the individual preforms comprise two half-cylinders with semi-circular cross sections. In this manner the two half cylinder preforms may be combined to fill a cylindrical extrusion apparatus. Generally, the shape of the initial preforms will depend upon the final shape of the extruder and number of individual layers desired in the finished tape article. For example, a multilayer tape article comprising three functional layers can be constructed in a rectangular extruder comprising three rectangular preforms comprising the desired functional characteristics. Alternately, the preform may be constructed by filling a mold sideways with layers of PTFE compositions comprising different functionalities, then rotating the preform 90 degrees before charging the preform to the extruder.

The composite preform is then ram extruded to produce a multilayer tape product. In a preferred embodiment of the present invention, the preform fits tightly into the inside of the extruder. The preform is pushed with a ram to force the preform through a nozzle or die. The extruded PTFE tape article emerges having three distinct cross sectional regions. A first layer comprises the composition and functional properties of the first preform, and a second layer comprises the composition and functional properties of the second preform. Between these two primary layers lies a tie layer comprising material from the first and the second preforms. This tie layer is formed during the ram extrusion of the composite preform.

The force exerted on the composite preform during ram extrusion promotes interfacial fibrillation between the individual preforms resulting in a finished tape article having a multilayer configuration corresponding to the original preforms with tie layer therebetween. The tie layer comprises properties of the two initial preforms and is critical to the inter-layer adhesion of the two primary layers. As the composite preform passes through the die, the material in the boundary region of the individual preforms becomes fibrillated and the fibrils intertwine, intermesh or otherwise tangle together to form a mechanical bond between the different types of PTFE.

While not wanting to be bound by the theory, the current belief is that individual PTFE chains along the boundary between the two preforms are forced to straighten out and elongate by the force and pressure supplied by the ram. As the chains from both preforms elongate, some of them intermesh and entangle. Some of the chains then relax and begin to curl up forming little balls. This action is similar to running a pair of scissors along a ribbon and causing it to curl up amongst itself. Chains that are intertwined sometimes curl together thereby locking the initially separate and distinct PTFE chains together forming a physical bond between the two types of PTFE within the tie layer. This tie layer is generally quite small as compared to the overall thickness of the tape, generally less than 0.001% of the total thickness of the tape. However, the degree of fibrillation and mechanical bonding is sufficient to alleviate the problems of the prior art.

This interstitial fibrillation does not occur in traditional multi-layer manufacturing such as lamination. Thus, the final product of the present invention exhibits a bond between the layers comprising a co-mingling of the fibrils which was heretofore unachievable. The two distinct PTFE components are mechanically bonded through the tie layer thereby preventing the separation problems experienced in prior art attempts.

### EXAMPLE

In one embodiment of the present invention, a final tape product comprising the functional characteristics of enhanced abrasion resistance and laser markability is desired. As discussed in U.S. patent application Ser. No. 09/992,776 (Pub. No. 2002/0082320), entitled “Abrasion-Resistant Polytetrafluoroethylene Tape”, herein incorporated by reference, that the addition of 1 to 3% by weight poly-p-oxybenzoate to a polytetrafluoroethylene-polyphenylene sulfide composition greatly enhances abrasion resistance. Further, it is known from U.S. Pat. No. 6,833,178, discussed infra, that the addition of polyimide to a PTFE-based tape greatly improves the arc track resistance of the finished product.

Therefore, the first step is to create two preforms comprising the individual functionalities desired in the final product, namely abrasion resistance and laser markability. First, the particulate polyphenylene sulfide, poly-p-oxybenzoate and a fine powder extrudeable polytetrafluoroethylene resin are mixed, then air milled to produce a uniform dispersion of said polyphenylene sulfide, poly-p-oxybenzoate, and said polytetrafluoroethylene resin. The uniform dispersion is blended with an extrusion aid comprising a hydrocarbon solvent to produce a blend comprising poly-p-oxybenzoate, polyphenylene sulfide, polytetrafluoroethylene resin, and extrusion aid. The blend is then formed into a preform suitable for ram extrusion comprising a half cylinder shape by charging the blend into a mold and applying pressure to fuse the blend into a solid form.

Similarly, a second preform is constructed by mixing a metal oxide such as titanium oxide, with a PTFE resin and an extrusion aid, then charging the second mixture into a mold and applying pressure to fuse the mixture into a solid form. Preferably, the first and second preforms fit together to create a composite preform having the shape and fitting snugly into the cylinder of a ram extruder.

The composite preform is then ram extruded to create a tape product comprising abrasion resistance provided by the material of the first preform and exemplified by a first layer, and laser markability provided by the material of the second preform and exemplified in a second layer. The two distinct layers are mechanically bonded together through a tie layer disposed therebetween comprising a mixture of the two primary layers and formed from the fibrillation and mechanical intermixing of the two compositions.

The geometric configuration made from the preform may be selected from the group consisting of tapes and tubing. In a preferred embodiment the preform is extruded into a tape. Once formed, the material may then be sintered and exposed to laser radiation for encoding the material. Also disclosed are the materials produced by the various combinations of processes encompassed by such process.

Although the present invention has been described with reference to particular embodiments, it should be recognized that these embodiments are merely illustrative of the principles of the present invention. Those of ordinary skill in the art will appreciate that the apparatus and methods of the present invention may be constructed and implemented in other ways and embodiments. Accordingly, the description herein should not be read as limiting the present invention, as other embodiments also fall within the scope of the present invention.

1. A process for producing a multilayer multifunctional fluoropolymer-based tape comprising:
a) selecting a first fluoropolymer-based composition comprising a first functional property;
b) selecting a second fluoropolymer-based composition comprising a second functional property different from said first functional property;
c) forming a first preform from said first fluoropolymer-based composition;
d) forming a second preform from said second fluoropolymer-based composition;
e) loading the first and second preforms into an extruder;
f) actuating a ram to force said first and second preforms through a die to form an extruded product comprising a first layer and a second layer physically bonded through a tie layer disposed therebetween;
wherein said tie layer comprises a mixture of the material of said first layer and said second layer formed through interstitial fibrillation of the two layers during extrusion.

2. The process of claim 1, wherein said first functional property comprises at least one of markability, abrasion resistance, arc track resistance, flexibility, bondability, stretchability, wear resistance, heat aging and weathering, insulative properties, porosity, UV resistance, and hydraulic resistance.

3. The process of claim 2, wherein said second functional property comprises at least one of markability, abrasion resistance, arc track resistance, flexibility, bondability, stretchability, wear resistance, heat aging and weathering, insulative properties, porosity, UV resistance, and hydraulic resistance, wherein said second functional property is not equal to said first functional property.

4. A finished article comprising two primary layers and a tie layer comprising a mixture of the material of the two primary layers formed through the process of claim 1.

5. A multilayer fluoropolymer based tape comprising a first layer having a first functional property, a second layer comprising a second functional property and an interstitial tie layer formed from the fibrillation of said adjoining first and second layers during extrusion.
